(19) United States
(12) Patent Application Publication
(10) Pub. No.: US 2011/0030020 A1
(43) Pub. Date: Feb. 3, 2011

(54) METHOD OF ORDERING A VIDEO FILM WITH A MOBILE TERMINAL SUCH AS A MOBILE PHONE AND TRANSFERRING IT TO A TV

(75) Inventor: Lasse Halttunen, Järvenpää (FI)

Correspondence Address: BIRCH STEWART KOLASCH & BIRCH, PO BOX 747, FALLS CHURCH, VA, 22040-0747, US

(73) Assignee: LH Communications Oy, JÄRVENPÄÄ (FI)

(21) Appl. No.: 12/937,179

(22) PCT Filed: Apr. 7, 2009
(86) PCT No.: PCT/FI09/50260

§ 371 Date: Oct. 8, 2010

(30) Foreign Application Priority Data
Apr. 9, 2008 (FI) 20080277

(51) Int. Cl. H04N 7/173

(52) U.S. Cl. 725/98

(57) ABSTRACT

The invention is relates to a method where a video film or a multimedia presentation is ordered from an operator or a publisher of a newspaper. The operator sends a film or a multimedia presentation or a newspaper to a mobile phone e.g. via radio broadcasting in a 3G network or via Internet. The video film or multimedia presentation or the newspaper is transferred from the mobile phone by means of Bluetooth connection to a TV accessory that is connected to a TV and which converts the signals so that they are suitable for a TV. This video film or multimedia presentation can thus be watched and heard on TV by means of the mobile phone accessory or a newspaper can be read on the TV screen.

This invention relates to a method of ordering a video film or a multimedia presentation or subscribing a newspaper with a mobile terminal such as a mobile phone and transferring it to an ordinary television receiver by using a mobile terminal accessory according to the preamble of the claim 1. The invention relates to all mobile communication generations, such as 1G, 2G, 3G and 4G, of which at this moment especially third generation UMTS (Universal Mobile Tele Communications System) terminal equipments, all kind of GSM applications, such as: WAP (Wireless Access Protocol), HSCSD (High Speed Circuit Switch Data), HSDPA (High-Speed Downlink Packet Access), GPRS (General Packet Radio Service), EDGE (Enhanced Data Rates for GSM Evolution) and CDMA (Code Division Multiple Access) phones and IMT (International Mobile Telecommunication) 2000 data terminal equipments.

Previously known in the art is that mobile phones have their own displays where all information is viewed. So far the display has mainly been integrated into the phone device.

A problem with the above described prior art is that a small display of mobile phone does not give right to many applications such as to watch a video film or a multimedia presentation by means of a mobile phone or to read Internet pages or a newspaper. These are going to be the most used applications in the future. Monitors developed for instance UMTS mobile phones are expensive and cannot thus be used at many homes but are used only in business environment. Further several users have poor eyesight so that the small size of a mobile phone display is a bigger problem when watching for example a multimedia presentation.

The object to this invention is to eliminate the disadvantages of the prior art described above and achieve a new method which can be used for ordering a video film with a mobile phone and transferring it to a screen of an ordinary television and at the same time hear the sounds from the television receiver by means of a mobile phone accessory.

The invention discloses a method to order a video film or a multimedia presentation or to subscribe a newspaper by sending an identification code to an operator or a publisher which identification code the mobile phone has received with Bluetooth connection from the TV accessory as a response to an order agreement which the user has sent. First the operator's or publisher's order agreement has been sent from the mobile phone with Bluetooth connection to the TV accessory which agreement the owner of the mobile phone has received earlier for example form Internet or in another way. After that the above mentioned identification code is thus sent with the mobile phone to the operator. After that the operator sends a movie or a multimedia presentation or a newspaper to the mobile phone for example via radio in a 3G network or via Internet. The video film or multimedia presentation or the newspaper is transferred with Bluetooth to the TV accessory that has been connected to the TV and which transforms the signals to suitable TV video and audio signals. This video film or multimedia presentation can thus be watched on TV by means of the mobile phone accessory or a newspaper can be read. The video film or multimedia presentation or the newspaper can be stored in the mobile phone or the TV accessory or the TV memory.

Instead of a mobile phone a computer, such as a laptop, may also be used.

The identification code sent to the operator can be customer specific and can be also used as a discount code giving a chance for the operator to offer different services to different consumer segments. One important group is young people who in addition to films can order games which they play directly with their mobile phones so that all the persons that are in the same place can see the games on a TV screen.

The operator can sell these TV accessories and has had an opportunity to program this TV accessory so that it suits for his services whereby a fixed identification code has been programmed to the accessory. The TV accessory is connected either directly to the SCART connector or alternatively to the TV antenna connector whereby the signals are normal TV broadcasting signals.

In detail the characterising features of the invention has been presented in the enclosed independent claims and preferred embodiments in other claims.

In the following the invention is described in more detail by means of an example by reference to the enclosed drawings wherein

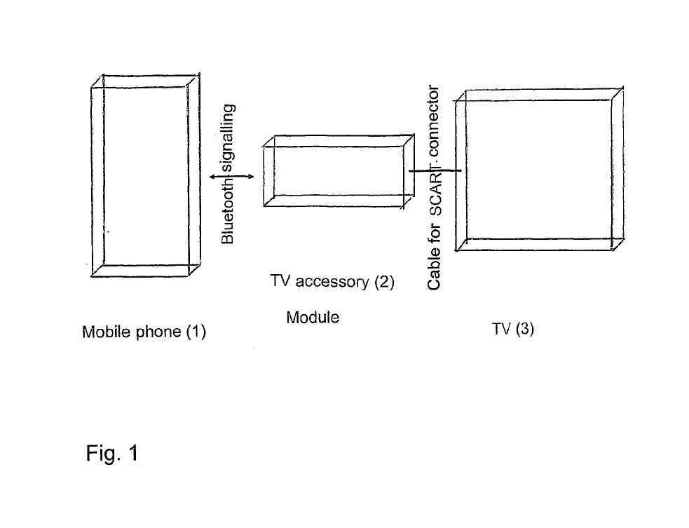

FIG. 1 presents the system according to the present invention,

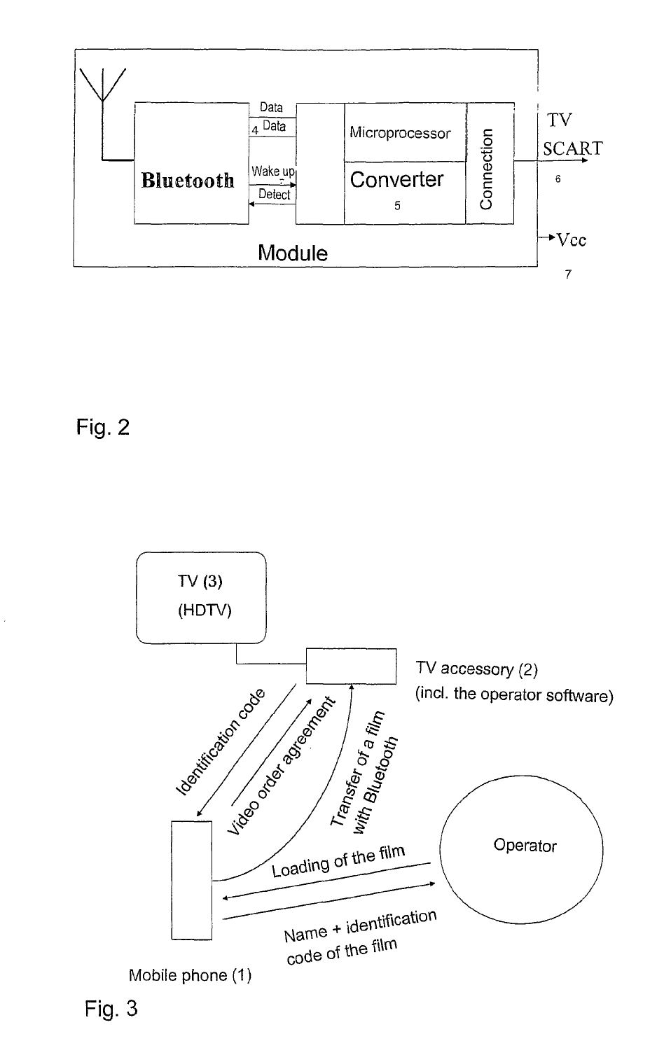

FIG. 2 a block diagram of a converter and

FIG. 3 an operation scheme of the video film ordering.

A mobile phone (1) utilizes a standard Bluetooth connection by means of which the user can send a video film with sound received by the mobile phone to the television receiver accessory nearby in the air interface in the free 2.4 GHz frequency band.

The module (2) is coupled to the SCART-connector of the TV (1), the module having SCART-compatible connector parts. The module comprises a Bluetooth receiver and a converter. Electricity supply comes from a separate transformer, which is connected to 220 V mains supply.

The module (2) receives signals transmitted from the mobile phone (1), e.g. UMTS data terminal equipment, using the Bluetooth accessory and converts signals according to all types of different devices from each manufacturer, image signals into RGB-signals and sound signal parts into sound signals required by the TV.

More precisely the method according to the invention is characterized in that, the mobile phone (1) receives sound and image information from the mobile phone network and by pressing a certain soft key button the phone copies image information and control information from the display to the Bluetooth transmitter and combines sound information to those. Former takes place according to different types of phones from each manufacturer. After that the phone transmits it by Bluetooth transceiver equipment to a TV-receiver (3) nearby, into which a module (2) is connected. In addition to the actual converter part, the module comprises a receiving Bluetooth accessory, which receives image and sound transmitted by the mobile phone, e.g. UMTS data terminal equipment, and converts these to RGB-control signals and sound. This takes place according to different types of phones from each manufacturer. The Bluetooth receiver in the module is connected to a converter.

Substantial advantages are achieved through this invention.

The invention enables that mobile phone, e.g. UMTS, CDMA, etc., will be used because of the new services much more than today, also in home usage. Viewing Internet pages, if there is no PC for home usage, can be done more consumer friendly through an already existing TV.

Furthermore, home usage of video phone is enabled through television screen and sound, for example when using UMTS at home, one can watch his/her dialog partner more clearly through a bigger TV-screen. Also a video received with the mobile phone can be watched with the TV, when e.g. watching a movie becomes easier and a satisfactory volume can be achieved.

Playing games received from a mobile phone network gets easier by using a TV-screen. Altogether watching bigger images from TV in spare time compared to a mobile phone display creates ease in use.

Signalling Explanation:
The patent does not respond to the mobile phone function regarding to the radio network and thus does not intervene to the part of signalling where the radio network base station and mobile phone transmit and receive internationally agreed radio network signals
The patent does neither respond to Bluetooth signalling, which adhere to internationally agreed signals

Connection Explanation:
The mobile phone, e. g. UMTS data terminal equipment, connection is based on manufacturers' methods and the patent does not take that into consideration
The converter, which is based on signal processing, can process control signals with the Bluetooth part and converts image and sound information transmitted from the mobile phone to signals (RGB+sound) required by TV
The module's connection to TV
   The module is connected physically and mechanically to the SCART-connector in the television
   Description of the used SCART-connection:

SCART Pin-Configuration:
1. Audio out, right, 0.5V rms/<1 kohm
2. Audio in, right, 0.5V rms/>10 kohm
3. Audio out, left/mono, 0.5V rms/<1 kohm
4. Audio ground
5. Blue ground
6. Audio in, left/mono 0.5V rms/>10 kohm
7. RGB blue, 0.7V 75 ohm
8. Function select, TV/AV, >10 kohm
9. Green ground
10. Data 2
11. RGB green, 0.7V 75 ohm
12. Data 1
13. Red ground
14. Data ground
15. RGB red, 0.7V 75 ohm
16. Connection signal (Blanking signal), video/RGB, 75 ohm
17. Composite video ground
18. Blanking signal ground
19. Composite video out 1V/75 ohm
20. Composite video in 1 V/75 ohm
21. Shield

Pin Description:

10, 12 and 14. Generally brand related controlling. These are not necessarily in use.

16. With this blanking signal transfer mode is chosen. 0-0.4V=composite video. 1-3V=RGB signal.

21. Shield. The connector metal frame is being coupled to this connection.

In the conventional SCART-cable between the TV and the VCR, usually only pins 1, 2, 3, 4, 6, 8, 17, 19 and 20 are coupled.

Audio and video inputs and outputs are connected crosswise in the cable. Pin 8 is wired also from the other end to pin 8. Pins 4 and 17 are coupled from both ends to the cable protecting shield.

1. Method of ordering a video film or a alike with a mobile terminal, like a mobile phone (1) or a laptop and transferring it to a TV (3),
characterized in that
an operator's video film order agreement or a multimedia order agreement or a publisher's newspaper subscribing agreement is sent from a mobile terminal such as a mobile phone or a laptop by means of a wireless short range connection, such as Bluetooth or WLAN, to a TV accessory,
the mobile terminal receives an identification code from the TV accessory via the short range connection, such as Bluetooth or WLAN, as a response to an order agreement which the user has sent,
a video film or a multimedia presentation is ordered or a newspaper is subscribed with the mobile terminal by sending specifying data, such as the name of the movie an/or an identification code, to an operator or a publisher,
the operator or publisher sends the film or the multimedia presentation or newspaper to the mobile terminal,
the TV has an accessory connected to it, for example to its SCART connection capable of receiving and sending short range, like Bluetooth, signalling,
a video film or a multimedia presentation or a newspaper is transferred from the mobile phone with the wireless short range connection, like Bluetooth or WLAN, to the TV accessory which has been connected to the TV and converts the signals so that they are TV compatible,
a video film or a multimedia presentation can be watched or a newspaper can be read on TV by means of the TV accessory.

2. Method according to claim 1, characterized in that that based on an identification code the operator can define the clients in many different ways, among others provide discounts to a certain group etc.

3. Method according to claim 1, characterized in that the operator or publisher has programmed the TV accessory.

4. Method according to claim 1, characterized in that a video film can be stored in a mobile terminal or TV accessory or TV memory.

5. Apparatus of ordering a video film or alike with a mobile terminal such as a mobile phone (1) or a laptop and transferring it to a TV (3),
characterized in that the apparatus is adapted to operate as follows:
an operator's video film order agreement or a multimedia order agreement or a publisher's newspaper subscribing agreement is sent from a mobile terminal such as a mobile phone or a laptop by means of a wireless short range connection, such as Bluetooth or WLAN, to a TV accessory,
the mobile terminal receives an identification code from the TV accessory via the short range connection, such as Bluetooth or WLAN, as a response to an order agreement which the user has sent,
a video film or a multimedia presentation is ordered or a newspaper is subscribed with the mobile terminal by sending specifying data, such as the name of the movie an/or an identification code to an operator or a publisher,
the operator or publisher sends the film or the multimedia presentation or newspaper to the mobile terminal,
the TV has an accessory connected to it, for example to its SCART connection capable of receiving and sending short range, like Bluetooth, signalling,
a video film or a multimedia presentation or a newspaper is transferred from the mobile phone with the wireless short range connection, like Bluetooth or WLAN, to the TV accessory which has been connected to the TV and converts the signals so that they are TV compatible,
a video film or a multimedia presentation can be watched or a newspaper can be read on TV by means of the TV accessory.
